(19) United States
(12) Patent Application Publication
(10) Pub. No.: US 2010/0245264 A1
(43) Pub. Date: Sep. 30, 2010

(54) Optical Detection Apparatus and Method

(75) Inventors: Ming-Cho Wu, Taoyuan County (TW); Ching-Hui Lin, Taipei City (TW)

Correspondence Address: BRIAN M. MCINNIS, 12th Floor, Ruttonjee House, 11 Duddell Street, Hong Kong, HK

(73) Assignee: ARIMA LASERS CORP., Taoyuan County (TW)

(21) Appl. No.: 12/414,674

(22) Filed: Mar. 31, 2009

(51) Int. Cl. G06F 3/041; G01B 11/14

(52) U.S. Cl. 345/173; 356/623

(57) ABSTRACT

In the specification and drawing, an optical detection apparatus is described and shown with scanning devices, detectors, and a processing unit, wherein the scanning devices are positioned to scan a detection region with different light wavelengths.

### BACKGROUND

1. Field of Invention

The present disclosure relates to a touch panel. More particularly, the present disclosure relates to a touch panel including optical detection means.

2. Description of Related Art

“Touch panel” is a device that can detect the presence and location of a touch within the detection region. Various types of touch panel, such as a resistive touch panel, a capacitive touch panel, and an optical touch panel, have been developed for such purpose.

One embodiment of the present invention relates to a touch panel including optical detecting means.

### SUMMARY

According to one embodiment of the present invention, an optical detection apparatus includes a first and second scanning devices, a first and second detectors, and a processing unit. The first and second scanning devices are respectively positioned to scan a detection region with a first and second light beams, in which incident angles of the first and second light beams respectively vary with time and the wavelength of the first light beam is different from the wavelength of the second light beam. The first and second detectors are respectively positioned to detect a first and second time signals upon which the first and second light beams are respectively reflected by a touch within the detection region. The processing unit is operative to determine a location of the touch within the detection region by the first and second time signals and the incident angles of the first and second light beams by way of triangulation.

According to another embodiment of the present invention, an optical detection method includes the following steps of:

(1) scanning a detection region respectively with a first and second light beams, in which incident angles of the first and second light beams respectively vary with time, and the wavelength of the first light beam is different from the wavelength of the second light beam;

(2) detecting a first and second time signals upon which the first and second light beams are respectively reflected by a touch within the detection region; and

(3) determining a location of the touch within the detection region by the first and second time signals, and the incident angles of the first and second light beams by way of triangulation.

### BRIEF DESCRIPTION OF THE DRAWINGS

FIG. 1 is a front view of an optical detection apparatus according to one embodiment of the present invention;

FIG. 2 is a graph of the incident angle of the first light beam versus time;

FIG. 3 is a graph of the first time signal versus time; and

FIG. 4 is a three dimensional view of an optical detection apparatus according to another embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

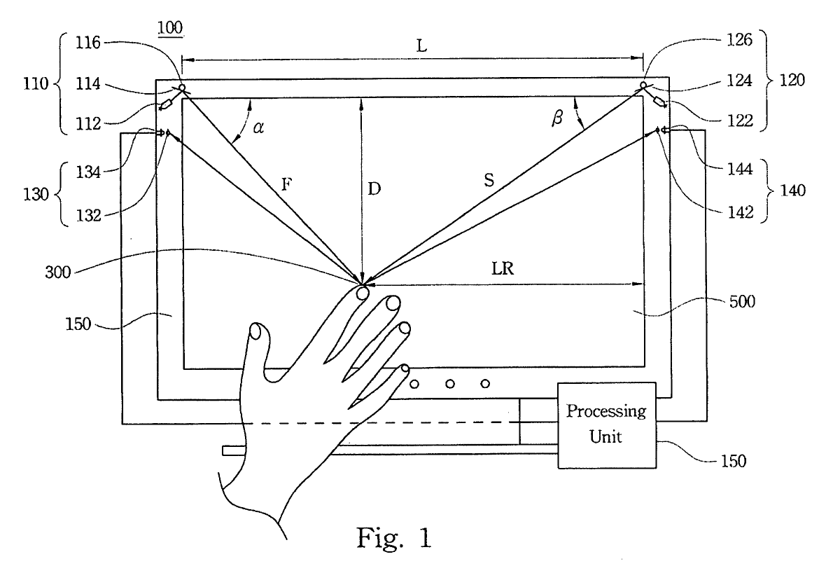

FIG. 1 is a front view of an optical detection apparatus 100 according to one embodiment of the present invention. The optical detection apparatus 100 includes a first scanning device 110, a second scanning device 120, a first detector 130, a second detector 140 and a processing unit 150. The first scanning device 110 is positioned to scan a detection region 500 with a first light beam F. The second scanning device 120 is positioned to scan the detection region 500 with a second light beam S. The wavelength of the first light beam F is different from the wavelength of the second light beam S. The first detector 130 is positioned to detect a first time signal upon which the first light beam F is reflected by a touch 300 within the detection region 500. The second detector 140 is positioned to detect a second time signal upon which the second light beam S is reflected by the touch 300 within the detection region 500. The processing unit 150 is operative to determine a location of the touch 300.

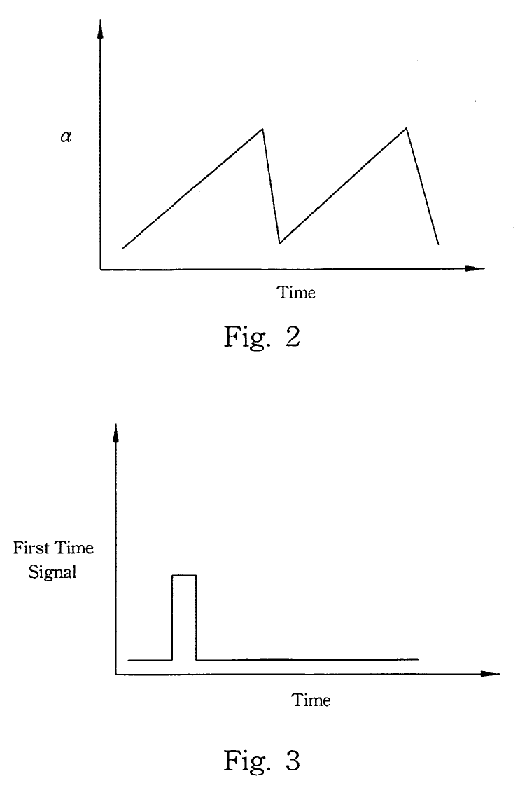

Specifically, the first scanning device 110 includes a light source 112, a mirror 114 and a rotating actuator 116. The light source 112 is operative to generate the first light beam F. The mirror 114 is positioned to receive the first light beam F and subsequently direct the first light beam F into the detection region 500. The rotating actuator 116 is coupled to the mirror 114 for rotating the mirror 114 and thereby varying the incident angle α of the first light beam F in accordance with a driving signal provided by a controller, such as a motor controller integrated circuit (IC). That is, the incident angle α of the first light beam F can vary with time (as shown in FIG. 2).

Similarly, the second scanning device 120 includes a light source 122, a mirror 124 and a rotating actuator 126. The light source 122 is operative to generate the second light beam S. The mirror 124 is positioned to receive the second light beam S and subsequently direct the second light beam S into the detection region 500. The rotating actuator 126 is coupled to the mirror 124 for rotating the mirror 124 and thereby varying the incident angle β of the second light beam S in accordance with a driving signal provided by a controller, such as a motor controller integrated circuit (IC). That is, the incident angle β of the second light beam S can vary with time as well.

The light sources 112/122 may be laser diodes, for example 780 nm laser diodes (such as ADL-78101-TL available from Arima Lasers Corporation), 808 nm laser diodes (such as ADL-80Y01-TL available from Arima Lasers Corporation) or 850 nm laser diodes (such as ADL-85051-TL available from Arima Lasers Corporation), such that both the first light beam F and the second light beam S are collimated light beams. In the present embodiment, the light source 112 may be a 780 nm laser diode, and the light source 122 may be an 850 nm laser diode. Accordingly, the wavelength of the first light beam F is 780 nm, and the wavelength of the second light beam S is 850 nm.

It is appreciated that many other devices may be used as the light sources 112/122, for instance, light emitting diodes may be substituted for the laser diodes as the light sources 112/122.

The first scanning device 110 and the second scanning device 120 may be spaced apart from each other by a pre-determined distance. More particularly, the mirrors 114/124 may be spaced apart from each other by a pre-determined distance, for example the length L of the top side of the detection region 500.

The first detector 130 may include a narrow band pass filter 132 and a photodetector 134. The narrow band pass filter 132 is positioned to distinguish the first light beam F from the second light beam S. The photodetector 134 is positioned to convert the first light beam F into the first time signal. As shown in FIG. 3, the first time signal may be a pulse, which indicates the time when the first light beam F is received by the photodetector 134, i.e. the time when the first light beam F is reflected by the touch 300.

Similarly, the second detector 140 may include a narrow band pass filter 142 and a photodetector 144 as well. The narrow band pass filter 142 is positioned to distinguish the second light beam S from the first light beam F. The photodetector 144 is positioned to convert the second light beam S into the second time signal. The second time signal may also be a pulse, which indicates the time when the second light beam S is received by the photodetector 144, i.e. the time when the second light beam S is reflected by the touch 300.

The photodetectors 134/144 may be photodiodes. It is appreciated that many other devices may be used as the photodetectors 134/144, for instance, phototransistors may be substituted for the photodiodes as the photodetectors 134/144.

Since the incident angle α of the first light beam F is a function of time (as shown in FIG. 2), if the time when the first light beam F is reflected by the touch 300 is known, then the incident angle α of the first light beam F at the time when the first light beam F is reflected by the touch 300 would be known as well. Furthermore, the incident angle β of the second light beam S at the time when the second light beam S is reflected by the touch 300 can be obtained by a similar way.

The coordinates and distance to the touch 300 can be found by calculating the length L of the top side of the detection region 500, given the incident angle α of the first light beam F at the time when the first light beam F is reflected by the touch 300 and the incident angle β of the second light beam S at the time when the second light beam S is reflected by the touch 300. Specifically, the distance D between the top side of the detection region 500 and the touch 300 may be obtained by the following Formula I:

D=U(1/tan α+1/tan β) Formula I

Thereafter, the distance LR between the right side of the detection region 500 and the touch 300 may be obtained by the following Formula II:

LR=D cot β Formula II

Therefore, the location of the touch 300 may be described as (LR,D) by the Cartesian coordinate system.

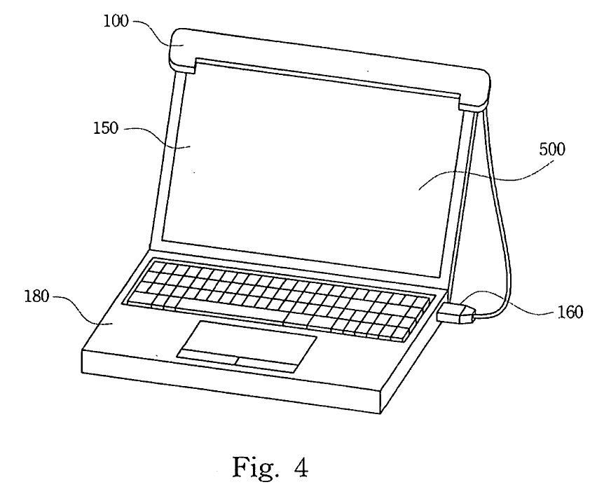

In use, the optical detection apparatus 100 may be integrated into a display panel 200 (as shown in FIG. 1) or removably mounted on the display panel 200 (as shown in FIG. 4). Accordingly, the optical detection apparatus 100 and the display panel 200 can be operative as a touch screen.

As shown in FIG. 4, there may be a communication module 160 positioned to transmit the location of the touch to a computer 180. The communication module 160 may be, for example, a human interface device (HID) bus, an universal serial bus (USB), a Bluetooth communication module or other wireless communication module.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An optical detection apparatus comprising:
a first and second scanning devices respectively positioned to scan a detection region with a first and second light beams, in which incident angles of the first and second light beams respectively vary with time and the wavelength of the first light beam is different from the wavelength of the second light beam;
a first and second detectors respectively positioned to detect a first and second time signals upon which the first and second light beams are respectively reflected by a touch within the detection region; and
a processing unit operative to determine a location of the touch within the detection region by the first and second time signals and the incident angles of the first and second light beams by way of triangulation.

2. The optical detection apparatus of claim 1, wherein the first and second detectors respectively comprise:
a narrow band pass filter positioned to distinguish the first light beam from the second light beam; and
a photodetector positioned to convert the reflected first and second light beams respectively into the first and second time signals.

3. The optical detection apparatus of claim 2, wherein the photodetector is a photodiode or a phototransistor.

4. The optical detection apparatus of claim 1, wherein the first and second scanning devices respectively comprise:
a light source operative to respectively generate the first and second light beams;
a mirror positioned to respectively receive the first and second light beams and subsequently direct the first and second light beams respectively into the detection region; and
a rotating actuator coupled to the mirror for respectively rotating the mirror and thereby varying the incident angles of the first and second light beams in accordance with a driving signal.

5. The optical detection apparatus of claim 4, wherein the mirrors of the first and second scanning devices are spaced apart from each other.

6. The optical detection apparatus of claim 4, wherein the light source is a laser or a light-emitting diode.

7. The optical detection apparatus of claim 4, wherein the light source is a 780 nm laser diode or an 850 nm laser diode.

8. The optical detection apparatus of claim 1, further comprising:
a communication module positioned to transmit the location of the touch to a computer.

9. The optical detection apparatus of claim 8, wherein the communication module is a human interface device (HID) bus, an universal serial bus (USB), a Bluetooth communication module, or a wireless communication module.

10. A touch screen comprising:
a display panel; and
the optical detection apparatus as recited in claim 1, wherein the optical detection apparatus is removably mounted on the display panel or is integrated into the display panel.

11. An optical detection method comprising:
scanning a detection region respectively with a first and second light beams, in which incident angles of the first and second light beams respectively vary with time, and the wavelength of the first light beam is different from the wavelength of the second light beam;
detecting a first and second time signals upon which the first and second light beams are respectively reflected by a touch within the detection region; and
determining a location of the touch within the detection region by the first and second time signals and the incident angles of the first and second light beams by way of triangulation.

12. The optical detection method of claim 11, wherein detecting the first and second time signals respectively comprise:
distinguishing the first light beam from the second light beam; and
converting the reflected first and second light beams into the first and second time signals, respectively.

13. The optical detection method of claim 11, wherein the first and second light beams are collimated light beams.

14. The optical detection method of claim 11, wherein the wavelength of the first light beam is 780 nm and the wavelength of the second light beam is 850 nm.

15. The optical detection method of claim 11, wherein scanning the detection region respectively with the first and second light beams comprises:
directing the first and second light beams respectively to a mirror and subsequently into the detection region, in which the mirror is coupled to a rotating actuator for rotating the mirror and thereby respectively varying the incident angles of the first and second light beams.

16. The optical detection method of claim 11, further comprising:
transmitting the location of the touch to a computer.

17. The optical detection method of claim 16, wherein the transmitting step is performed by a human interface device (HID) bus, an universal serial bus (USB), a Bluetooth communication module, or a wireless communication module.
